(19) United States
(12) Patent Application Publication
(10) Pub. No.: US 2026/0316735 A1
(43) Pub. Date: Oct. 15, 2026

(54) METHOD FOR OPERATING A VALVE ARRANGEMENT FOR ACTIVATING A PARKING BRAKE FUNCTION AT STANDSTILL, COMPUTER PROGRAM AND/OR COMPUTER-READABLE MEDIUM, CONTROL UNIT, ELECTROPNEUMATIC PARKING BRAKE SYSTEM, VEHICLE

(71) Applicant: ZF CV Systems Europe BV, Brussels (BE)

(72) Inventors: Julian van Thiel, Grossburgwedel (DE); Janik Ricke, Uetze-Eltze (DE); Thomas Dieckmann, Pattensen (DE); Karl-Heinz Riediger-Janisch, Hannover (DE); Robert Otremba, Ronnenberg (DE)

(21) Appl. No.: 19/689,298

(22) Filed: May 27, 2026

Related U.S. Application Data
(63) Continuation of application No. PCT/EP2024/082346, filed on Nov. 14, 2024.

(30) Foreign Application Priority Data
Nov. 27, 2023 (DE) 10 2023 133 085.3

(51) Int. Cl. B60T 13/68; B60T 13/38; F16D 65/00

(52) U.S. Cl. CPC B60T 13/683; B60T 13/385; F16D 65/0006

(57) ABSTRACT

A method is for operating a valve arrangement to activate a parking brake function at standstill for an electropneumatic parking brake system of a vehicle, in particular a utility vehicle. The valve arrangement has an outlet valve arrangement and a pilot control arrangement controllable via a pilot control signal, and the valve arrangement can be switched via a switching signal into a noise-reducing first venting mode or a rapid-venting second venting mode. The method includes: detecting trigger information; determining, on the basis of the trigger information, the switching signal and, for the first venting mode, the pilot control signal; and outputting the switching signal to the outlet valve arrangement and, for the first venting mode, the pilot control signal to the pilot control arrangement.

### CROSS-REFERENCE TO RELATED APPLICATIONS

This application is a continuation application of international patent application PCT/EP2024/082346, filed Nov. 14, 2024, designating the United States and claiming priority from German application 10 2023 133 085.3, filed Nov. 27, 2023, and the entire content of both applications is incorporated herein by reference.

### TECHNICAL FIELD

The disclosure relates to a method for operating a valve arrangement for activating a parking brake function at standstill for an electropneumatic parking brake system of a vehicle, in particular a utility vehicle. The disclosure also relates to a computer program and/or computer-readable medium, a control unit for an electropneumatic parking brake system of a vehicle, in particular a utility vehicle, an electropneumatic parking brake system for a vehicle, in particular a utility vehicle, including a control unit, and a vehicle, in particular a utility vehicle,

### BACKGROUND

For modern vehicles, reducing noise emissions is becoming increasingly important with the increasing electrification of drive systems, in particular for vehicles that are partially and/or exclusively electrically powered. The standstill of the vehicle is particularly noteworthy in this context, as driving noises are typically minimal when the vehicle is stationary, which means that vehicle-related noises may be particularly noticeable.

One source of noise can be a pneumatic system, in particular an electropneumatic braking system. Such systems include a compressed air supply and/or a compressor that can apply air pressure to an inlet valve. The inlet valve is connected to the working volume of a pneumatic actuator, which releases a flow of air through an outlet valve during and/or after actuation, Noise can be generated in particular when air is released or vented through the outlet valve. It is possible to throttle the release, However, throttling the release can have an influence on the actuation of the actuator.

For example, an electropneumatic parking brake system can emit comparatively loud noises when a parking brake function is activated, that is, when the parking brake is applied.

Patent application DE 10 2023 104 841 describes a valve arrangement for a pneumatic system of a vehicle, in particular a utility vehicle, including: an outlet valve arrangement for venting the pneumatic system, a control unit for operating the valve arrangement for aerating and venting a pneumatic actuator, wherein the control unit is configured to output a switching signal for switching the outlet valve arrangement to the outlet valve arrangement, and the outlet valve arrangement can be switched to a noise-reducing first venting mode or a rapid-venting second venting mode on the basis of the switching signal.

### SUMMARY

It is an object of the disclosure to enhance and improve upon the prior art. One embodiment achieves the object of reducing noise emissions during venting when applying a pneumatic parking brake.

The object is, for example, achieved by various methods, electropneumatic parking brake systems, and vehicles according to the disclosure.

According to an aspect of the disclosure, a method is provided for operating a valve arrangement for activating a parking brake function at a standstill for an electropneumatic parking brake system of a vehicle, in particular a utility vehicle, wherein the valve arrangement has an outlet valve arrangement and a pilot control arrangement controllable via a pilot control signal, and the valve arrangement can be switched via a switching signal into a noise-reducing first venting mode or a rapid-venting second venting mode, and wherein the method includes: detecting trigger information; determining, on the basis of the trigger information, the switching signal and, for the first venting mode, the pilot control signal; and outputting the switching signal to the outlet valve arrangement and, for the first venting mode, the pilot control signal to the pilot control arrangement.

The disclosure is based on the fact that noise-reducing measures in the outlet valve arrangement or in a venting part are generally often accompanied by a reduction or limitation of venting gradients. This throttles the venting. However, since high gradients for venting, that is, rapid venting, are not always absolutely necessary, it is envisaged that the venting mode can be changed on the basis of the switching signal in order to be able to operate the outlet valve arrangement in the first venting mode in a noise-reducing manner or in the second venting mode in a rapid-venting manner.

In other words, the disclosure provides for selective venting of the electropneumatic parking brake system in the noise-reducing first venting mode or the rapid-venting second venting mode. In this case, the activation of the parking brake function, that is, the application of the parking brake, particularly when the vehicle, in particular a utility vehicle, is stationary, is carried out either in a noise-reducing manner or in a time-optimized or gradient-optimized manner, depending on the trigger information. To operate the pilot control arrangement in the first venting mode, the pilot control signal can also be determined on the basis of the trigger information. The switching signal can be output to the outlet valve arrangement in order to perform venting in the first venting mode or the second venting mode, whereby, in the case of venting in the first venting mode, the pilot control signal can also be output to a pilot control arrangement. In the second venting mode, the pilot control signal may be dispensable.

This allows an electropneumatic parking brake system to be operated which is configured to switch between noise-reducing venting and fast or gradient-optimized venting. The corresponding mode is activated by the switching signal output by the control unit, which can be determined on the basis of the trigger information. The trigger information can reflect a particular vehicle situation and/or the urgency or criticality of the respective venting in order to initiate venting through the outlet valve arrangement accordingly.

According to various embodiments, the pilot control signal has a venting profile that depends on pressure and/or time. In the noise-reducing first venting mode, when the parking brake function is activated, a pilot control pressure can be modulated by the pilot control arrangement via a preselected venting profile in order to vent the parking brake system, instead of venting as quickly as possible by simply switching the outlet valve. The venting profile can define the control of the pilot control valve as a function of pressure and/or time. The venting profile can be constant over time. Alternatively or additionally, the pilot control signal is configured to regulate a predetermined volume flow, For this purpose, the pilot control signal can define a venting cross-section for venting that is particularly pressure-dependent. The venting cross-section of a valve in the valve arrangement defines the volume flow that can be output from the parking brake system and is therefore controllable.

According to various embodiments, the method includes: detection of vehicle- and/or environment-related parameters; and adjustment of the pilot control signal taking the parameters into account. This allows, In particular, the venting profile to be parameterized so that it can be adapted to the respective vehicle configuration and/or driving situation. Furthermore, the venting profile can also be influenced by environmental conditions such as an incline or a slope on which the vehicle is to be parked. The parameters can be used to estimate the extent to which noise reduction and/or the fastest possible activation of the parking brake function is required.

According to various embodiments, the pilot control signal is set up to control a smaller volume flow of the pilot control arrangement at a higher pressure than at a lower pressure. At higher pressures, a spring accumulator can initially be vented with a comparatively small volume flow or with a correspondingly small venting cross-section. As the pressure in the spring accumulator decreases, however, a larger volume flow or a correspondingly larger venting cross-section can be applied. This is a particularly effective way of reducing noise, as noise emissions result in particular from the volume flow at comparatively high pressures.

According to various embodiments, the pilot control signal defines a pulsed control of the pilot control arrangement. The pilot control signal can define the pulsed control of the pilot control arrangement, particularly for the noise-reducing first venting mode. Pulsed control refers to time-modulated or alternating and/or periodic control of the pilot control arrangement. The ventilation cross-section can be varied over time in accordance with the control signal and, in particular, can be alternately increased and decreased. The pulsed control allows a balance to be achieved between noise reduction and the ventilation requirements of the parking brake system. For this purpose, the valve arrangement is optionally configured to fully open a venting path in the second venting mode and/or to open the venting path in the first venting mode partially, intermittently and/or in a pulsed manner.

According to various embodiments, the method includes: Outputting a service brake signal for the time-limited operation of an electropneumatic service brake system. It has been recognized that, particularly in the noise-reducing first venting mode, when the parking brake function is activated, the service brake can initially be activated in order to bridge the transition from a deactivated parking brake function or a released position to an activated parking brake function or the engaged position of the parking brake. This ensures that, after a request to activate the parking brake function has been made, the vehicle can be held securely even for a potentially extended transition or engagement time due to venting in the first venting mode, while at the same time reducing noise emissions.

According to various embodiments, the detection of the trigger information includes a user input. A user or driver of the vehicle can enter the user input via a control element or a user interface. The user input is an example of trigger information for switching between the noise-reducing first venting mode and the rapid-venting second venting mode.

According to various embodiments, the parking brake function can be activated by a binary request signal. It has been recognized that the parking brake function should typically be activated to keep the vehicle stationary. Therefore, a binary request signal for activating and/or deactivating the parking brake is sufficient to request a well-defined actuation of the parking brake system.

According to an aspect of the disclosure, a computer program and/or a computer-readable medium is provided. The computer program and/or the computer-readable medium includes/include commands which, when the program or the commands is or are executed by a control unit, cause the latter to carry out the method according to the disclosure and/or steps of the method. The computer program and/or the computer-readable medium optionally include(s) commands which, when the program or the commands is or are executed by a control unit, cause the latter to carry out the method steps described as being advantageous or optional, in order to obtain a technical effect associated therewith.

According to an aspect of the disclosure, a control unit for an electropneumatic parking brake system of a vehicle, in particular a utility vehicle, with a valve arrangement is provided, wherein the valve arrangement has an outlet valve arrangement and a pilot control arrangement controllable via a pilot control signal, and the valve arrangement can be switched via a switching signal into a noise-reducing first venting mode or a rapid-venting second venting mode, and the control unit is configured to carry out the above-described method. According to various embodiments, the control device is configured to implement one or more of the features described as optional and/or advantageous with reference to the method in order to achieve a technical effect associated therewith.

According to an aspect of the disclosure, an electropneumatic parking brake system is provided for a vehicle, in particular a utility vehicle, wherein the vehicle, in particular utility vehicle, includes the control unit described above and a valve arrangement with an outlet valve arrangement and a pilot control arrangement controllable via a pilot control signal, wherein the valve arrangement can be switched via a switching signal into a noise-reducing first venting mode or a rapid-venting second venting mode. According to various embodiments, the electropneumatic parking brake system is configured to implement one or more of the features described as optional and/or advantageous with reference to the method in order to achieve a technical effect associated therewith.

According to an aspect of the disclosure, a vehicle, in particular a utility vehicle, is provided including the control unit and/or the electropneumatic parking brake system described above. According to various embodiments, the vehicle, in particular utility vehicle, is configured to implement one or more of the features described as optional and/or advantageous with reference to the method in order to achieve a technical effect associated therewith,

### BRIEF DESCRIPTION OF DRAWINGS

The invention will now be described with reference to the drawings wherein:

FIG. 1 shows a schematic illustration of a vehicle, in particular a utility vehicle, according to an aspect of the disclosure;

FIG. 2 shows a schematic illustration of a valve arrangement of an electropneumatic parking brake system according to an aspect of the disclosure;

FIG. 3 shows a schematic illustration of a flow chart of a method according to an aspect of the disclosure; and,

FIG. 4 shows a schematic illustration of a computer-readable medium according to an aspect of the disclosure.

### DETAILED DESCRIPTION

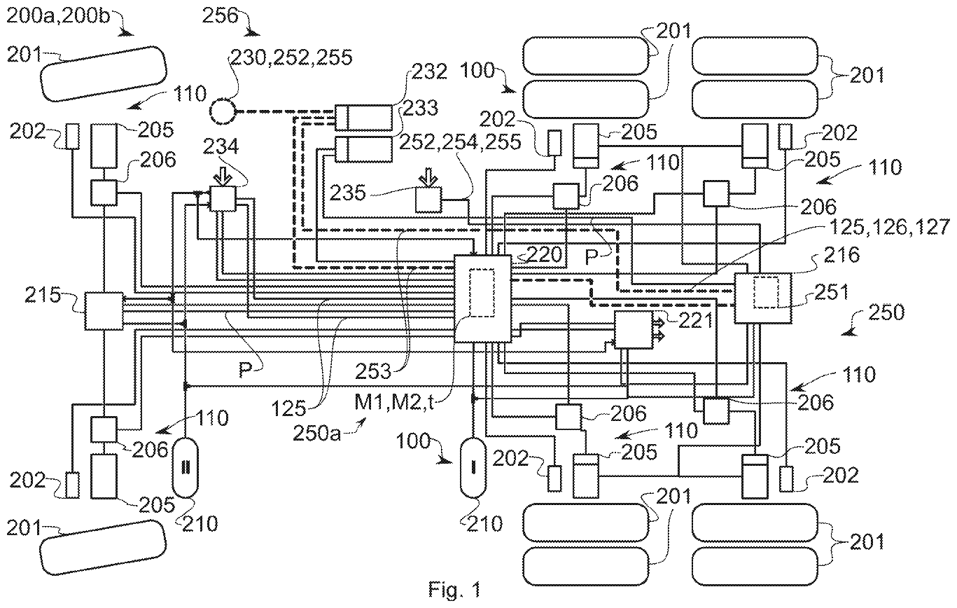

FIG. 1 shows a schematic illustration of a vehicle 200a, in particular a utility vehicle 200b, according to an aspect of the disclosure. The vehicle 200a, in particular utility vehicle 200b, is referred to below as vehicle 200a, 200b. The vehicle 200a, 200b is a land vehicle, in particular a towing vehicle of a multi-unit vehicle 200a, 200b. In another embodiment, the vehicle 200a, 200b may be a single-unit vehicle 200a, 200b and/or a trailer vehicle (not shown).

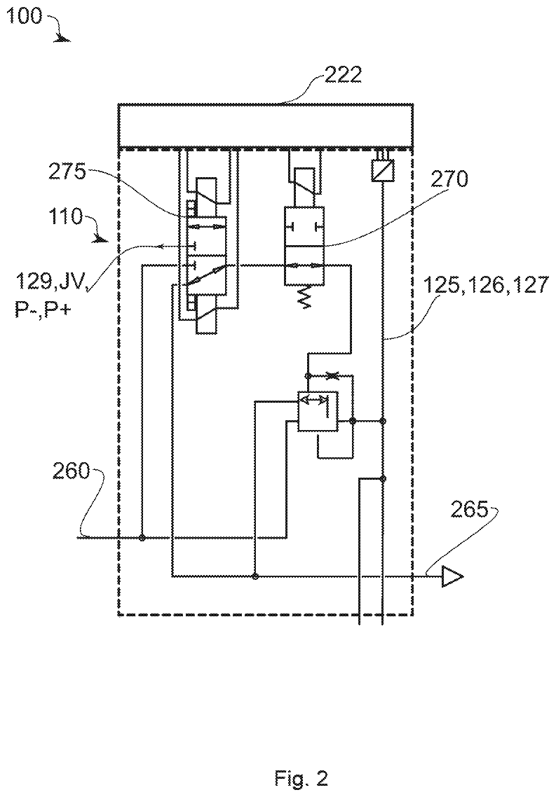

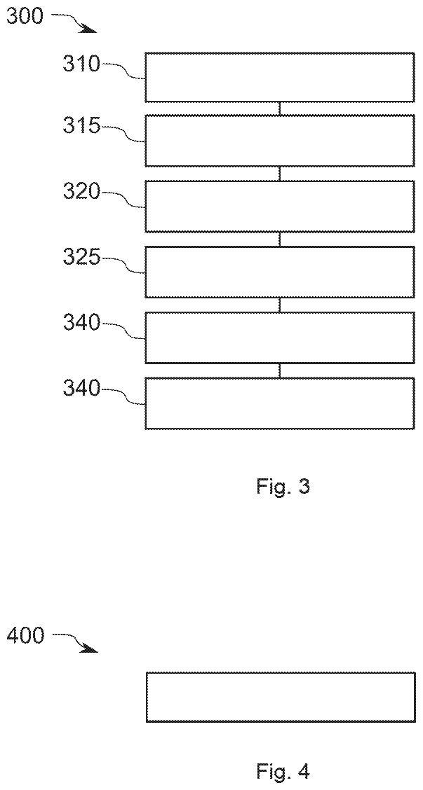

The vehicle 200a, 200b according to FIG. 1 is configured to carry out the method 300 described with reference to FIG. 3. For this purpose, the vehicle 200a, 200b according to FIG. 1 has an electropneumatic parking brake system 250 with a control unit 220 (see FIG. 2) and a valve arrangement 100. The control unit 220 and the valve arrangement 100 are also described with reference to FIG. 2.

The vehicle 200a, 200b according to FIG. 1 has an electropneumatic service brake system 250a and a brake value sensor 234. The brake value generator 234 may, for example, include a brake pedal with a valve substructure to convert a driver-side brake request into a signal for operating the electropneumatic service brake system 250a and/or to convert a brake request mediated by an automated driving function 230 into a signal for operating the electropneumatic service brake system 250a. The brake value sensor 234 is connected to the control unit 220 via communication technology in order to transmit the brake request to the control unit 220.

The vehicle 200a, 200b has a front axle modulator 215. The front axle modulator 215 (FAM) is configured to operate components of the electropneumatic service brake system 250a and a corresponding outlet valve arrangement 110 relating to a front axle of the vehicle 200a, 200b. The front axle modulator 215 is connected to the brake value sensor 234 and to the control unit 220 for communication purposes in order to receive a signal corresponding to the brake request for braking.

The vehicle 200a, 200b has a rear axle modulator 216 (RAM) and a parking brake module 217, wherein the control unit 220 is configured as the rear axle modulator 216. The rear axle modulator 216 is configured to operate components of the service braking system 250a relating to the rear axles of the vehicle 200a, 200b. The parking brake module 217 is configured to operate the electropneumatic parking brake system 250. The parking brake module 217 is connected to the brake value sensor 234 via the control unit 220 in order to receive a signal corresponding to the brake request for actuating the service brake system 250a.

The parking brake module 217 is configured to control the parking brake function 251 of the parking brake system 250. In particular, the parking brake module 217 is configured to activate the parking brake function 251 of the parking brake system or to apply a parking brake, in particular when the vehicle 200a, 200b is at a standstill 256. The parking brake function 251 causes the vehicle 200a, 200b to be held at a standstill 256.

The front axle modulator 215 and the parking brake module 217 are connected to the control unit 220 and the rear axle modulator 216, respectively, for communication purposes and are configured to sense a pressure P, P+, P− relating to the brake system 250′ and to transmit it to the control unit 220.

The vehicle 200a, 200b has a parking brake switch 235 for actuating the parking brake system 250 and for controlling the parking brake function 251. The parking brake switch 235 is a user interface at which a user and/or driver of the vehicle 200a, 200b can make a user input 235 to operate the parking brake system 250, The user input 235 may also include trigger information 252 for actuating the parking brake system 250, The parking brake switch 235 and the control unit 220 or the rear axle modulator 216 are each connected to the rear axle modulator 216 via communication technology in order to transmit the user input 235 or the trigger information 252 to the parking brake module 217. In another embodiment (not shown), the parking brake switch 235 is directly connected to the control unit 220 for communication purposes in order to transmit the user input 235 and the trigger information 252 to the control unit 220.

The vehicle 200a, 200b includes two compressed air reservoirs 210. The compressed air reservoirs 210 are each configured to provide compressed air for operating the parking brake system 250 and the service brake system 250a. For this purpose, the compressed air reservoirs 210 are each configured to compress air and/or store compressed air. The compressed air reservoirs 210 are pneumatically connected to actuators 205 via the front axle modulator 215, the rear axle modulator 216 and/or the parking brake module 217.

The vehicle 200a, 200b or the parking brake system 250 and the service brake system 250a has a plurality of actuators 205. Each of the actuators 205 can be supplied with air from the compressed air supply 210 and can thus be ventilated to achieve a braking effect. To control the ventilation, the valve arrangement 100 has inlet valves (not shown).

The valve arrangement 100 includes an outlet valve arrangement 110. The outlet valve arrangement 110 is configured to vent, that is, release air from, a working volume (not indicated) of each of the actuators 205 and thus the parking brake system 250 or the service brake system 250a. The valve arrangement 100 is thus configured to aerate and vent the working volume of the actuators 205.

The control unit 220 is configured to record the trigger information 252 or the user input 254 and process it to control the parking brake function 251. For this purpose, the control unit 220 can be connected to the rear axle modulator 216 via the vehicle bus 232, as illustrated by a dashed line. The parking brake function 251 can be activated by a binary request signal 255. The binary request signal 255 can thus define whether the parking brake function 251 is activated or deactivated. The request signal 255 relates to the user input 254 or an automated driving function 230, which may include trigger information 252. The automated driving function 230 or a signal relating to the automated driving function can be transmitted via the vehicle bus 232 to the control unit 220 and/or the rear axle modulator 216.

The control unit 220 is configured to detect vehicle-and/or environment-related parameters 253, For this purpose, the vehicle 200a, 200b has sensors (not shown) for detecting one or more such parameters 253, The sensors are connected to the control unit 220 via the vehicle bus 233 in order to transmit the parameters 253 to the control unit 200 and/or to transmit sensor data to the control unit 220, which can determine the parameters 253 via data processing. One such parameter 253 is, for example, an inclination of the vehicle 200a, 200b. For this purpose, the vehicle 200a, 200b has an inclination or position sensor (not shown) which is configured to detect the inclination and transmit it to the control unit 220.

The control unit 220 is configured to determine a switching signal 125 based on the trigger information 252. The outlet valve arrangements 110 can be switched to a noise-reducing first venting mode M1 or a rapid-venting second venting mode M2 on the basis of the switching signal 125. The control unit 120 is configured to output the switching signal 125 taking into account the vehicle- and/or environment-related parameter 253. According to the switching signal 120, the outlet valve arrangements 110 can thus be switched to the first venting mode M1 or the second venting mode M2, wherein it is also possible to transition between the modes.

The control unit 220 is configured to determine a pilot control signal 126 for the first venting mode M1 on the basis of the trigger information 252, In accordance with the pilot control signal 126, venting via the outlet valve arrangement 110 can be controlled in the first venting mode M1. The pilot control signal 126 defines the mode of operation of the outlet valve arrangement 110 in the first venting mode M1.

The pilot control signal 126 has a venting profile 127 that depends on the pressure P and/or a time t. The venting profile 127 determines a venting cross-section of a venting path 129 of the valve arrangement 100 (see also FIG. 2), The venting cross-section of the venting path 129 defines a volume flow JV that can be output via the venting path 129. Thus, the venting cross-section of the venting path 129 defines the venting of the parking brake system 250 in particular and thus the noise emission caused by the venting of the parking brake system 250. The pilot control signal 126 is configured to control a smaller volume flow JV of the pilot control arrangement 115 at a higher pressure P+than at a lower pressure P− (see also FIG. 2). The volume flow JV is measurable and the pilot control signal 126 can be configured to regulate a predetermined volume flow JV. The predetermined volume flow JV can be determined on the basis of the expected noise emission and can optionally be time-dependent.

The pilot control signal 126 defines a pulsed control of the pilot control arrangement 115. This allows a pulsed change in the venting cross-section of the venting path 129 to be defined in order to achieve an average volume flow JV and an associated noise emission. The pulsed control can define a temporary, for example alternating complete or partial, opening and closing of the venting path 129 for this purpose.

The control unit 220 is configured to adjust the pilot control signal 126 taking into account the parameters 253.

The control unit 220 is configured to output the switching signal 125 to the outlet valve arrangement 110. In addition, the control unit 22 is configured to output the pilot control signal 126 to the pilot control arrangement 115 for the first venting mode M1. To this end, the control unit 220 can transmit the switching signal 125, the pilot control signal 126 and the venting profile 127 to the rear axle modulator 216, which uses them to control the outlet valve arrangement 110.

The control unit 220 is configured to output a service brake signal 128 for the time-limited operation of an electropneumatic service brake system 250a. Therefore, a request to activate the parking brake function 251 for pressure control by the service brake system 250a can be transmitted from the parking brake system 250 to the service brake system 250a. The pressure P to be controlled by the service brake system 250a can be parameterized and thus adapted to a respective vehicle configuration and/or environmental conditions. In addition, the pressure P of the service brake system 250a can also be reduced as the pressure P of the parking brake system 250 decreases, depending on the pressure P of the parking brake system 250 or the resulting parking brake force.

The parking brake switch 235 can, for example, be configured as a parking brake actuator button or a parking brake rocker switch.

As an example of a user input 235 or trigger information 252, a brief actuation of the parking brake switch 235 is detected as a trigger for noise-optimized application of the parking brake, that is, for activation of the parking brake function 251 of the parking brake system 250 in the first venting mode M1, and a longer and/or continuous actuation of the parking brake switch 235 as a trigger for gradient-optimized or time-optimized application of the parking brake, that is, for activation of the parking brake function 251 of the parking brake system 250 in the second venting mode M2. Alternatively or additionally, the gradient-optimized or time-optimized application of the parking brake can also only take place for the period of continuous actuation of the parking brake switch 235 and revert to the noise-optimized operating mode when the parking brake switch 235 is released. Continuous actuation is achieved, for example, after a parameterized waiting time of approximately 1 s.

The valve arrangement 100 includes one outlet valve device 110, in particular one outlet valve device 110 per wheel brake.

The outlet valve arrangement 110 has one ABS valve 206 per actuator 205 as a quick-venting valve. Each of the ABS valves 206 is connected to an actuator 205. Each of the actuators 205 is configured to brake a wheel 201 or a pair of wheels 201 of the vehicle 200a, 200b. The ABS valves 206 are configured to be operated as a fallback level in the second venting mode M2. The vehicle 200a, 200b includes two silencers (not shown), and the ABS valves 206 are configured to vent via the silencers in the first venting mode M1.

The vehicle 200a, 200b each has wheel speed sensors 202 connected to the control unit 220 for communication purposes. The wheel speed sensors 202 are each configured to detect the speed or rotational speed of one or more of the wheels 201 and to transmit this information to the control unit 220. The control unit 220 can process the detected speeds or rotational speeds and use them to initiate an automated driving function 230.

The vehicle 200a, 200b has a power supply 233 for providing electrical energy to the electropneumatic parking brake system 250 and the electropneumatic service brake system 250a. The power supply 233 is, for example, an electrochemical energy storage device and is electronically connected to the control unit 220. The control unit 220 can supply electrical energy to components of the parking brake system 250 and the service brake system 250a.

The vehicle 200a, 200b has a trailer vehicle control module 221, The trailer vehicle control module 221 is configured to connect the vehicle 200a, 200b to a trailer vehicle (not shown) via communication technology. The trailer vehicle control module 221 is connected to the control unit 220 for communication purposes. The control unit 220 can transmit information relating to the braking of the vehicle 200a, 200b to the trailer vehicle control module 221 or, via the trailer vehicle control module 221, to the trailer vehicle, for example a brake request and/or a signal for controlling the lighting system of the trailer vehicle.

FIG. 2 shows a schematic representation of a valve arrangement 100 of an electropneumatic parking brake system 250 according to an aspect of the disclosure. Such a parking brake system 250 and such a valve arrangement 100 are described with reference to FIG. 1. FIG. 2 is described with reference to FIG. 1.

The valve arrangement 100 is shown schematically with a valve control module 222 and one of the outlet valve devices 110. The valve control module 222 is connected, for example, to the control unit 220 and/or the rear axle modulator 216 for communication purposes in order to control the switching signal 125, the pilot control signal 126 and the venting profile 127 and, accordingly, the valve arrangement or the outlet valve arrangement 110.

The valve arrangement 100 can be supplied with compressed air pneumatically via a compressed air inlet 260. The compressed air inlet 260 is configured to supply the working volume of the actuator 205 with air from the compressed air supply 210 and thus ventilate it. For this purpose, the valve arrangement 100 has a main connection 265 which is pneumatically connected to the actuator 205.

The valve arrangement 100 or the outlet valve devices 110 has a venting path 129. For this purpose, the valve arrangement 100 is configured to fully open the venting path 129 in the second venting mode M2 and/or to open the venting path 129 in the first venting mode M1 partially, intermittently and/or in a pulsed manner. Fully opening the vent path 129 means providing a maximum vent cross-section. In this case, the volume flow JV and thus also the noise emission are at their maximum. Partially opening the vent path 129 means providing a reduced vent cross-section. This reduces the volume flow JV and thus also the noise emission, The outlet valve devices 110 have a hold valve 270 or a 2/2 hold valve and a bistable 3/2 valve. In order to control the outlet valve devices 110 or the valve arrangement 100 in a pulsed manner, the hold valve 270 can be controlled in a pulsed manner, that is, opened and closed alternately, via a pulsed control signal. For time-optimized application of the parking brake, that is, the second venting mode M2, the bistable 3/2 valve 275 is switched to the venting position and vented with maximum resulting nominal diameter. The venting path 129 includes a venting outlet of the 3/2 valve 275.

FIG. 3 shows a schematic illustration of flow chart of a method 300 according to an aspect of the disclosure, The method 300 according to FIG. 3 is a method 300 for operating a valve arrangement 100 to activate a parking brake function 251 at standstill 256 for an electropneumatic parking brake system 250 of a vehicle 200a, in particular a utility vehicle 200b, wherein the valve arrangement 100 has an outlet valve arrangement 110 and a pilot control arrangement 115 controllable via a pilot control signal 126, and the valve arrangement 100 can be switched via a switching signal 125 into a noise-reducing first venting mode M1 or a rapid-venting second venting mode M2. Such a vehicle 200a, 200b is described with reference to FIG. 1. Such a valve arrangement 100 is described with reference to FIG. 2. FIG. 3 is described with reference to FIGS. 1 and 2.

The method 300 according to FIG. 3 includes. Detecting 310 trigger information 252. The detection 310 of the trigger information 252 includes a user input 254. The parking brake function 251 can be activated by a binary request signal 255, The request signal 255 relates, for example, to the user input 254 and/or an automated driving function 230.

The method 300 includes: Detecting 315 vehicle-and/or environment-related parameters 253.

The method 300 includes: Determining 320, based on the trigger information 252, the switching signal 125 and for the first venting mode M1 of the pilot control signal 126.

The method 300 includes: Adjusting 325 the pilot control signal 126 taking into account the parameters 253. The pilot control signal 126 has a venting profile 127 that depends on a pressure P and/or a time t and/or is configured to regulate a predetermined volume flow JV. The pilot control signal 126 is configured to control a smaller volume flow JV of the pilot control arrangement 115 at a higher pressure P+than at a lower pressure P−. The pilot control signal 126 defines a pulsed control of the pilot control arrangement 115. For this purpose, the valve arrangement 100 is configured to fully open a venting path 129 in the second venting mode M2 and/or to open the venting path 129 in the first venting mode M1 partially, intermittently and/or in a pulsed manner.

The method 300 includes: Outputting 330 the switching signal 125 to the outlet valve arrangement 110 and, for the first venting mode M1, the pilot control signal 126 to the pilot control arrangement 115.

The method 300 includes: Outputting 340 a service brake signal 128 for the time-limited operation of an electropneumatic service brake system 250a.

FIG. 4 shows a schematic illustration of a computer-readable medium 400 according to an aspect of the disclosure. The computer-readable medium 400 includes commands (not shown) which, when the program or the commands is or are executed by a control unit 220, cause the latter to carry out the method 300 and/or the steps of the method 300 according to FIG. 3.

The commands may be present as a program code in any code or language, in particular in a code that is suitable for motor vehicle controllers. The computer-readable medium 400 may be or include any digital data storage device, such as a USB stick, a hard disk, a CD-ROM, an SD card, or an SSD card. The computer program does not necessarily have to be stored on such a computer-readable storage medium, but may also be retrieved externally via the Internet or in some other way.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

100 Valve arrangement
110 Outlet valve arrangement
115 Pilot control arrangement
125 Switching signal
126 Pilot control signal
127 Venting profile
128 Service brake signal
129 Venting path
200a Vehicle
200b Utility vehicle
201 Wheel
202 Wheel speed sensor
205 Actuator
206 ABS valve
210 Compressed air supply
215 Front axle modulator
216 Rear axle modulator
217 Parking brake module
220 Control unit
221 Trailer vehicle control module
222 Valve control module
230 Automated driving function
232 Vehicle bus
233 Energy supply
234 Brake transducer
235 Parking brake switch
250 Electropneumatic parking brake system
250a Electropneumatic service brake system
251 Parking brake function
252 Trigger information
253 Parameter
254 User input
255 Binary request signal
256 Standstill
260 Compressed air inlet
265 Main connection
270 Hold valve
275 3/2-way valve
300 Method
310 Detecting trigger information
315 Detecting parameters
320 Determining a switching signal
325 Adjustment
330 Outputting a switching signal
340 Outputting a service brake signal
400 Computer-readable medium
JV Volume flow
M1 Noise-reducing, first venting mode
M2 Rapid-venting, second venting mode
p Pressure
P+ Higher pressure
P− Lower pressure
Time

1. A method for operating a valve arrangement to activate a parking brake function at standstill for an electropneumatic parking brake system of a vehicle, wherein the valve arrangement has an outlet valve arrangement and a pilot control arrangement controllable via a pilot control signal, and the valve arrangement is configured to be switched via a switching signal into a noise-reducing first venting mode or a rapid-venting second venting mode, the method comprising:
detecting trigger information;
determining, based on the trigger information, the switching signal and, for the first venting mode, the pilot control signal; and,
outputting the switching signal to the outlet valve arrangement and, for the first venting mode, the pilot control signal to the pilot control arrangement.

2. The method of claim 1, wherein at least one of:
the pilot control signal has a venting profile dependent on at least one of pressure and time; and,
the pilot control signal is configured to regulate a predetermined volume flow,

3. The method of claim 1 further comprising:
detecting parameters, wherein the parameters are at least one of vehicle-related parameters and environment-related parameters; and,
adjusting the pilot control signal taking into account the parameters,

4. The method of claim 1, wherein the pilot control signal is configured to control a smaller volume flow of the pilot control arrangement at a higher pressure than at a lower pressure.

5. The method of claim 1, wherein the pilot control signal defines a pulsed control of the pilot control arrangement.

6. The method of claim 1, wherein the valve arrangement is configured to at least one of:
fully open a venting path in the second venting mode; and,
open the venting path in the first venting mode partially, intermittently and/or in a pulsed manner.

7. The method of claim 1 further comprising:
outputting a service brake signal for a time-limited operation of an electropneumatic service brake system.

8. The method of claim 1, wherein said detecting the trigger information includes a user input.

9. The method of claim 1, wherein the parking brake function is configured to be activated by a binary request signal.

10. The method of claim 1, wherein the vehicle is a utility vehicle,

11. A computer program configured, when executed by a control unit, to cause the control unit to carry out the method of claim 1.

12. A non-transitory computer-readable storage medium comprising commands which, when the commands are executed by a control unit, cause the control unit to carry out the method of claim 1.

13. control unit for an electropneumatic parking brake system of a vehicle with a valve arrangement to activate a parking brake function at standstill, the valve arrangement having an outlet valve arrangement and a pilot control arrangement controllable via a pilot control signal, and the valve arrangement is configured to be switched via a switching signal into a noise-reducing first venting mode or a rapid-venting second venting mode, the control unit comprising:
a processor;
a non-transitory computer readable medium having program code stored thereon;
said program code being configured, when executed by said processor, to
detect trigger information;
determine, based on the trigger information, the switching signal and, for said first venting mode, said pilot control signal; and,
output the switching signal to the outlet valve arrangement and, for the first venting mode, said pilot control signal to said pilot control arrangement.

14. The control unit of claim 13, wherein the vehicle is a utility vehicle.

15. An electropneumatic parking brake system for a vehicle, the electropneumatic parking brake system comprising:
a control unit;
a valve arrangement to activate a parking brake function at standstill, said valve arrangement including an outlet valve arrangement and a pilot control arrangement controllable via a pilot control signal;
said valve arrangement being configured to be switched via a switching signal into a noise-reducing first venting mode or a rapid-venting second venting mode;
said control unit being configured to:
detect trigger information;
determine, based on the trigger information, the switching signal and, for said first venting mode, said pilot control signal; and,
output the switching signal to the outlet valve arrangement and, for the first venting mode, said pilot control signal to said pilot control arrangement.

16. The electropneumatic parking brake system of claim 15, wherein the vehicle is a utility vehicle.

17. A vehicle comprising a control unit of claim 13.

18. The vehicle of claim 17, wherein the vehicle is a utility vehicle.

19. A vehicle comprising the electropneumatic parking brake system of claim 15.

20. The vehicle of claim 19, wherein the vehicle is a utility vehicle.
